(19) United States
(12) Patent Application Publication
(10) Pub. No.: US 2024/0062669 A1
(43) Pub. Date: Feb. 22, 2024

(54) READING AID SYSTEM AND METHOD

(71) Applicants: Rivka SELA, Tel Aviv (IL); Galit BASOK, Tel Aviv (IL)

(72) Inventors: Rivka SELA, Tel Aviv (IL); Galit BASOK, Tel Aviv (IL)

(21) Appl. No.: 17/889,317

(22) Filed: Aug. 16, 2022

(51) Int. Cl. G09B 5/06; G10L 13/02; G09B 19/06; G09B 17/00

(52) U.S. Cl. CPC G09B 5/06; G10L 13/02; G09B 19/06; G09B 17/006

(57) ABSTRACT

A reading aid system including a computer configured to connect to a text storage means; a computer screen; a headset operably connected to the computer; a user interface device operably connected to the computer; and a microphone operably connected to the computer. The computer includes a speech analysis and editing module configured to perform any or all of the following: (a) analyze the intonation and/or breathing of the narrator; (b) synchronize and edit to provide automatic synchronization between the narrator's reading and highlighting of the words; (c) edit a sentence to convert long sentences to shorter sentences; (d) synchronize the shorter sentences in the text and the narration, or vice versa; and (e) combine sentences and synchronization between the speech and the text.

### FIELD OF THE INVENTION

The present invention relates to reading aids, in particular for people learning a foreign language and with reading deficiencies.

### BACKGROUND OF THE INVENTION

Reading is a basic key to learning and for this reason many techniques have been devised to help people learn to read better.

Students with learning disabilities are typically not exposed to reading entire books. Due to the great effort involved in reading, such students commonly refrain from reading books. Fluency reading exercises that are performed with them, usually via passages of text, do not allow the students to experience the pleasure of reading (entire) books and do not accumulate sufficient reading hours to mater reading. Accumulation of numerous reading hours contributes to linguistic richness and expansion of world knowledge. “Echo Reading” allows the learner to experience the experience of reading an entire age-appropriate book more easily and with great accuracy.

It is believed that the following publications represent the relevant technology in the field: U.S. Pat. Nos. 9,679,496; 8,634,759; 10,210,769; US 2006/069558; http://img1.tapuz.co.il (Galit Basok, Merkaz Koren); US 2009/023120; US 2020/320,898; U.S. Pat. Nos. 4,895,519; and 4,708,657. The teachings of the aforementioned publications are incorporated by reference as if fully set forth herein.

### SUMMARY OF THE INVENTION

The present invention relates to systems and methods for providing aid in reading. The system and method may be particularly helpful for people with learning challenges and for those learning a new language.

According to one aspect of the present invention there is provided a reading aid system. The system includes (a) a computer, configured to connect to a text storage means; (b) a computer screen; (c) a headset operably connected to the computer; (d) a user interface device, operably connected to the computer; and e) a microphone, operably connected to the computer. The computer is configured to control audio features of text selected from the text storage means so as to vocalize a section of text, to pause at the end of the section of text to allow time for a user to vocally repeat that section of text, and to send the repeated vocalization to the headset of the user simultaneously to the repeated vocalization.

The system further includes a speech analysis and editing module configured to perform any or all of the following: (a) analyze the intonation and/or breathing of the narrator; (b) synchronize and edit to provide automatic synchronization between the narrator's reading, and the highlighting (or any such emphasis, e.g., underlining) of the words; and (c) edit a sentence to convert long sentences to shorter sentences, and ensure the shorter sentences are synchronous in the text and the narration (or vice versa—to combine sentences and ensure synchronization with between the speech and the text).

In accordance with another aspect of the present invention, there is provided a method of aiding a person in their reading. The method includes (a) accessing a text storage means; (b) choosing recorded text; (c) analyzing speech and editing text for performing any or all of the following: (i) analyzing the intonation and/or breathing of the narrator; (ii) synchronizing and editing to provide automatic synchronization between the narrator's reading and the highlighting of the words; and (iii) editing a sentence to convert long sentences to shorter sentences, and synchronizing the shorter sentences in the text with the narration, or vice versa, combining sentences and synchronizing between the speech and the text; (d) initiating an audio reading of the recorded text; (e) pausing of the reading of the recorded text to allow repeating of the just read text by the user; (f) providing audio of that repeating, to the user, simultaneously as the user repeats the text; (g) determining that the user has completed repeating of the text; and (h) resuming audio reading of text.

The reading aid system and method are designed to develop reading fluency among children and adults with learning disabilities and among speakers of a second language.

The system and method are designed to improve reading proficiency, which is the ability to read text quickly, fluently, with ease and automatically, so that little attention is paid to decoding the text. Such reading allows attention resources to be diverted in favor of the main purpose of reading, which is comprehension.

The system and method are also designed to improve reading fluency, which is a developmental skill that begins with the completion of a reading acquisition process, typically at the end of first grade, and continues throughout the elementary school years, until the mastery of reading is achieved.

The reader training process may be multilingual. The user is typically associated with a learning organization/center. The training itself may be done on the user's computer (with software compatible with Windows or iPad). Training data may be synchronized with the system, which can be situated in the cloud.

The reading aid system is an active system configured to learn the reading capabilities and level of the user and adapts itself to the user's reading pace (with the help of language analysis tools), and can allow the adjustment of font type and size to the user's needs.

The system is preferably cloud-based/Internet based and allows practice in any environment that is convenient for the user, preferably under the supervision of a therapist with expertise in learning disabilities.

Reading exercises can be recorded and stored in the cloud for the benefit of review by the therapist. The system can be configured to allow for periodic follow-up and analysis for each user.

A personal profile of the user can be built by the user, under the supervision of the therapist, and adjustment of the level of practice can be changed, depending on progress.

The system can be configured to allow a choice of books from a library, according to individual reading level and preferences, for example using text to speech technology.

The system can be configured to communicate with the user by writing or in a conversational manner. The selection of a book, its presentation, the instructions and comments of the system may be written and spoken at the same time.

The reading/training process may be interactive and dynamic. The user uses a computer or iPad and headphones during a reading practice session.

An announcer/narrator reads a sentence or part of a sentence, depending on the user's level. The user listens to the audio reading with headphones. The system shows the sentence just read in an adapted font on the screen (one sentence at a time) and each word read by the announcer may be illuminated or highlighted on the screen in turn (immersive reading).

After a portion (e.g. phrase or sentence) of the text is read, the audio recording is paused. The user then repeats the portion/sentence just read and hears that repetition simultaneously in the headphones.

The system waits for the user to complete the reading (repetition) and only then proceeds to read the next words/sentence. The end of the training may be accompanied by the collection of information and the user's opinions about the training. This data may be stored for the therapist's analysis.

The system may use reward and encouragement tools. At the end of reading an entire book, a certificate of appreciation may be issued to the user.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is a schematic of a reading aid system in accordance with embodiments of the present invention.

FIG. 2 is a flow diagram of a method of aiding a person in their reading in accordance with embodiments of the present invention.

FIG. 3 is a schematic of another exemplary reading aid system in accordance with embodiments of the present invention.

FIG. 4 is a flow diagram of a method of producing a reading aid in accordance with embodiments of the present invention.

FIGS. 5-6 show exemplary screen tools useful in the system and for the method, in accordance with the presently disclosed subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same or similar reference numbers will be used throughout the drawings and the following description to refer to the same and similar parts.

### DETAILED DESCRIPTION OF EMBODIMENTS

Illustrative embodiments of the invention are described below. In the interest of clarity, not all features/components of an actual implementation are necessarily described.

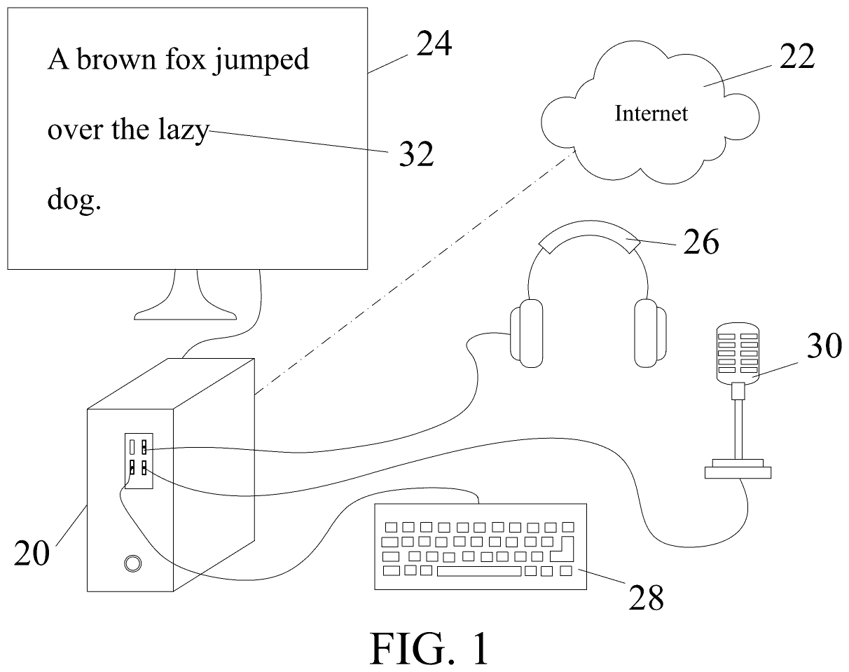

FIG. 1 shows a reading aid system of the present invention, in accordance with embodiments thereof. The system may be embodied by various means, for example, as a computer-based system (as illustrated), an Internet-based application, a self-study system, and so on. The exemplary system illustrated in FIG. 1 includes a computer 20, configured to connect to a text storage means, illustrated by the Internet 22; a computer screen 24; a headset 26 connected to the computer; a user interface device 28 such as a keyboard, connected to the computer; and a microphone 30, connected to the computer.

Computer 20 is configured to receive instructions and retrieve text 32, for example from a book, via the Internet (web site), via a computer disk, via a disk-on-key, or the like; and to display the text on computer screen 24. Computer 20 is also configured to retrieve/download an audio reading of text 32 and to transmit the audio to headset 26 for the user to hear, while the text is displayed on computer screen 24.

Computer 20 is further configured to stop the reading of text 32 at a predetermined time or text location (e.g., after a certain number of words of the text are read or at the end of phrases, etc.) or at a controllable time, at which time the user can repeat out loud the text that was just read, into microphone 30. The user may use keyboard 28 to control functions of computer 20, such as selecting a book/text, initiation of the reading, pausing the reading prior to repeating text 32, re-starting the reading, going back to an earlier point in the reading or skipping forward, marking the reading for continuing at another time and so on.

Computer 20 may be configured to compare the text to the trainee's speech and to algorithmically determine when a text passage has been fully read (even for slow readers, who may hesitate during reading) and only then resume the audio reading. Text 32 on display screen 24 may be highlighted during reading, and/or during repeating of the text by the user.

It is a particular feature of the reading aid that computer 20 is configured to play the user's reading back to the reader, in headset 26, at the same time as the user reads. Without limitation to theory, such “simultaneous read-back” can enhance the user's learning.

It should be noted that in some preferred embodiments, none of the aforementioned equipment need be specially configured to provide the reading aid technology disclosed herein. In accordance with some preferred embodiments, the technology is provided by the Internet, for example the “cloud”, and in particular may be provided by a website or application (“app”). In other words, computer 20 need not be configured to perform the above-mentioned activities, rather a web-based program may be accessed to provide the steps involved in the reading aid.

In some embodiments, the reading aid technology disclosed herein may be provided via an installed or installable computer program, for example via a USB flash drive (disk-on-key) or other such plug and play device. The reading material, as well as user instructions, can be provided in any language, and in multiple languages.

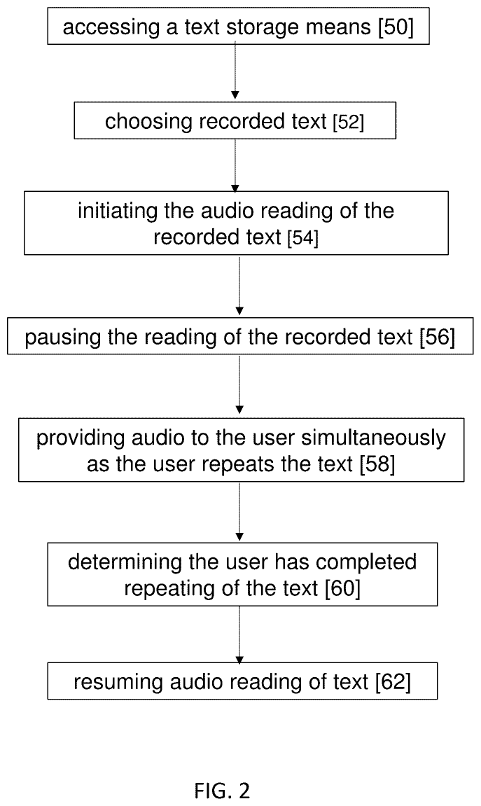

FIG. 2 shows an exemplary reading aid method. In some embodiments, the method includes the steps of accessing a text storage means (step 50), such as a website or a computer program installed in or accessible by computer 20; choosing recorded text (step 52), for example reading of a book, magazine article, or the like; initiating the audio reading of the recorded text (step 54); pausing of the reading of the recorded text (step 56) to allow repeating of the just read text by the user; providing audio of that repeating, to the user, simultaneously as the user repeats the text (step 58); determining that the user has completed repeating of the text (step 60); and resuming audio reading of text (step 62), or until the user chooses to stop, or until some predetermined point—for example an amount of text or time period.

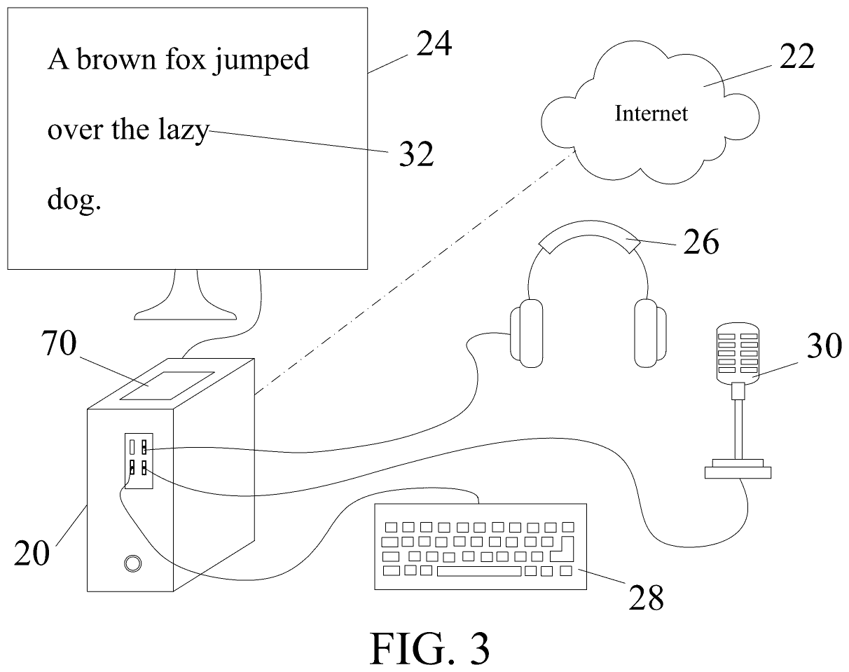

FIG. 3 shows another example of the reading aid system. This system is similar to that described with respect to FIG. 1; however, the system includes one or more built-in editor modules, such as a speech analysis and editing module 70, which for example may be built into computer 20, as illustrated. Speech analysis and editing module 70 may be configured to analyze the intonation and breathing of the narrator (i.e., hesitation of the narrator that might be consistent with a comma, whether the comma is present or not in the originally written text) and to add or subtract punctuation in the text and to provide synchronization (timing and/or wording) between the reading and the text. Also, the system (module 70) may be configured to edit (change) the pace/hesitations of the audible reading (after the narrator is finished reading), to suit the text (i.e., vice versa of editing the text to suit the audio/speech—in other words the system can edit the vocalization).

The system (e.g., editor module 70), may also be configured to correct reading mistakes of the narrator by parsing the narrator's sounds and affecting a “cut-and-paste” activity to correct a misspoken word. For example, if the text includes the word “bed” and the narrator accidentally says “fed”, the system (e.g. editor module 70) can locate a portion of the audio where the narrator said “bed” and substitute it for the incorrectly read word). Editor module 70 can also be configured to delete words.

Editor module 70 may also be configured to edit (change) the pace and/or hesitations of the audible recorded file produced by the narrator (i.e., after the narrator has finished reading and produced an audio file), to suit the originally written text. Additionally, or optionally, (i.e., this is vice versa of editing the text, the editor module can edit the vocalization).

The system (e.g., module 70) may also include a synchronization editing function that provides automatic synchronization between the narrator's reading, and the highlighting of the words. The system (module 70) may also include a sentence editing feature configured to edit long sentences to shorter sentences, and ensure the shorter sentences are synchronous in the text and the narration (or vice versa—to combine short sentences to produce a longer sentence and ensure synchronization between the speech and the text).

It should be clear that this system and method works for all situations where there is text and audio.

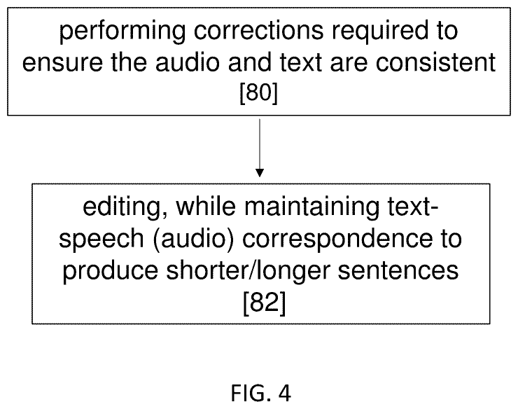

FIG. 4 illustrates a method of producing a reading aid in accordance with embodiments of the present invention. This method includes performing corrections required to ensure the audio and text are consistent 80; and may also include editing, while maintaining text-speech (audio) correspondence to produce shorter/longer sentences 82.

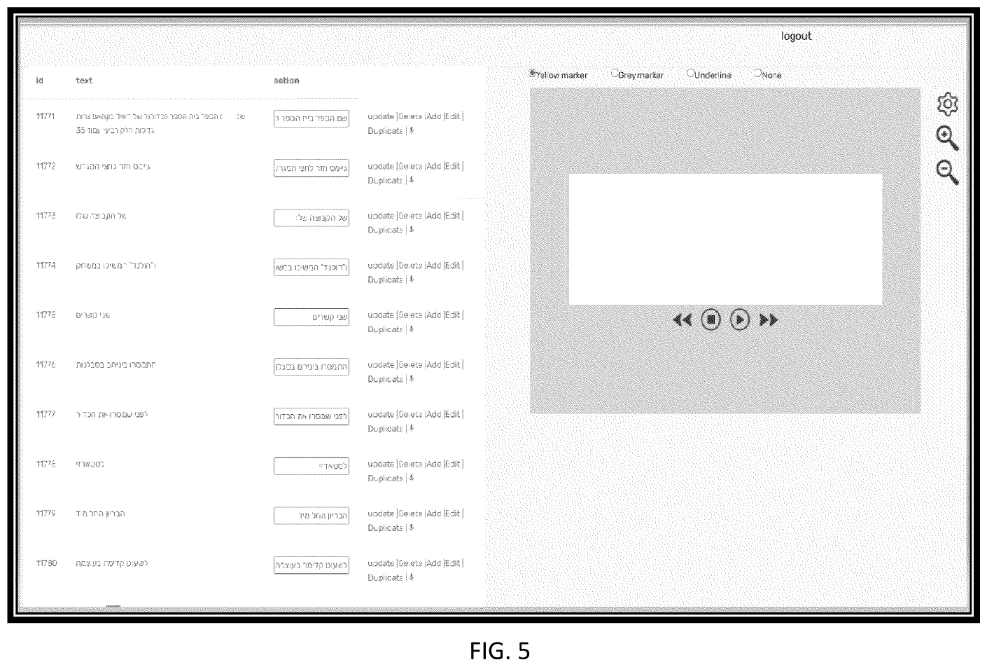

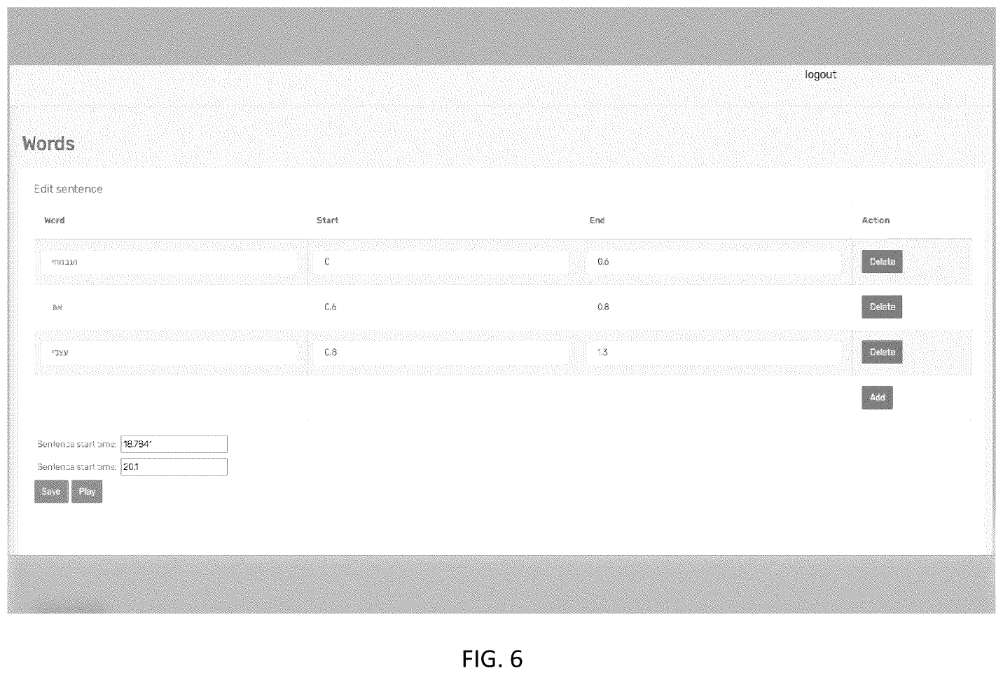

FIGS. 5-6 show a couple of exemplary screens illustrating program tools usable in the present system and present method of producing the reading aid, described above. useful in the system and for the method, in accordance with the presently disclosed subject matter. FIG. 5 illustrates exemplary options of text highlighting options, such as yellow, grey, and underline; as well as text parsing. FIG. 6 illustrates exemplary options of the system indicating the timing of individual words, for example, on the top row, the first word takes from 0.6 seconds to narrate, the beginning of that word's narration being at time=0, and the end being at time=0.6 seconds. Words/text can also be deleted or added, As understood from “delete” and “add” buttons.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A reading aid system comprising:
a computer configured to connect to a text storage means;
a computer screen;
a headset operably connected to the computer;
a user interface device operably connected to the computer; and
a microphone operably connected to the computer,
the computer configured to control audio features of text selected from the text storage means so as to vocalize a section of text, to pause at the end of the section of text to allow time for a user to vocally repeat that section of text, and to play a reading back of the section of text by the reader (user), to the reader (user), in the headset, at the same time as the user reads,
wherein learning is enhanced.

2. The system of claim 1, wherein the text storage means is an Internet web site.

3. The system of claim 1, wherein the text storage means is a USB flash drive.

4. The system of claim 1, configured to allow for a reader training process that is multilingual.

5. The system of claim 1, configured to be compatible with the user's computer or tablet computer.

6. The system of claim 1, configured so that training data may be synchronized with the system, and situatable in a communication network.

7. The system of claim 1, configured to be cloud-based.

8. The system of claim 1, configured to allow reading exercises to be recorded and stored in a communication network so as to allow review by a therapist.

9. The system of claim 1, configured to allow for periodic follow-up and analysis for each user.

10. The system of claim 1, configured to allow the user to build a personal profile.

11. The system of claim 1, configured to allow the user to adjust of a level of practice.

12. The system of claim 1, configured to allow a choice of books from a library, according to individual reading level and preferences.

13. The system of claim 1, configured to communicate with the user by writing or in a conversational manner.

14. The system of claim 1, configured so that the text that was read is displayed in an adapted font on the screen, one sentence at a time.

15. The system of claim 14, configured so that the text is illuminated or highlighted on the screen while being read.

16. The system of claim 1, configured to recognize when the user has finished repeating the text and only then proceeds to read subsequent text.

17. A method of aiding a user in reading, the method comprising:
(a) accessing a text storage means;
(b) choosing recorded text;
(c) playing a reading back of a section of the text by the reader, to the reader (user), in a headset, at the same time as the user reads, receiving the user's speech;
wherein learning is enhanced.

18. The method of claim 17, wherein accessing a text storage means comprises accessing a USB flash drive

19. The method of claim 17, wherein accessing a text storage means comprises accessing a communication network.

20. The method of claim 17, comprising recording and storing reading exercises in a communication network so as to allow review by a therapist.

21. The method of claim 17, comprising analyzing the progress of the user.

22. The method of claim 17, comprising building a personal profile.

23. The method of claim 17, comprising adjusting a reading level based on the user's progress.

24. The method of claim 17, comprising choosing books from a library, according to individual reading level and preferences.

25. The method of claim 17, comprising communicating with the user by writing or in a conversational manner.

26. The method of claim 17, comprising displaying text in an adapted font on a screen, one sentence at a time.

27. The method of claim 26, comprising illuminating or highlighting the text on the screen while being read.

28. The method of claim 18, comprising recognizing when the user has finished repeating the text and only then proceeding to read subsequent text.
